(19) United States
(12) Patent Application Publication
(10) Pub. No.: US 2016/0139842 A1
(43) Pub. Date: May 19, 2016

(54) STORAGE CONTROL APPARATUS AND STORAGE SYSTEM

(71) Applicant: FUJITSU LIMITED, Kawasaki-shi (JP)

(72) Inventors: Yasuyuki NAKATA, Kawasaki (JP); Naoki Kobayashi, Setagaya (JP)

(73) Assignee: FUJITSU LIMITED, Kawasaki (JP)

(21) Appl. No.: 14/939,326

(22) Filed: Nov. 12, 2015

(30) Foreign Application Priority Data
Nov. 19, 2014 (JP) 2014-234373

(51) Int. Cl. G06F 3/06

(52) U.S. Cl. CPC G06F 3/0619; G06F 3/065; G06F 3/0683

(57) ABSTRACT

A storage control apparatus includes a processor. The processor is configured to store partial progress information in a memory. The partial progress information is a part of progress information units of a predetermined size. The progress information units are obtained by dividing whole progress information stored in a storage device different from the memory. The whole progress information indicates progress of copy processing of copying data stored in a copy source region to a copy destination region. The processor is configured to perform the copy processing on basis of the partial progress information stored in the memory.

### CROSS-REFERENCE TO RELATED APPLICATION

This application is based upon and claims the benefit of priority of the prior Japanese Patent Application No. 2014-234373, filed on Nov. 19, 2014, the entire contents of which are incorporated herein by reference.

### FIELD

The embodiment discussed herein is related to a storage control apparatus and a storage system.

### BACKGROUND

One point copy (OPC) has been known as one of the methods for backing up a source volume (for example, an operation volume) in a storage apparatus. OPC is to create a snapshot, which is data at a given point of time, for data to be backed up. Upon receipt of an OPC instruction from a user, the storage apparatus to perform OPC backs up the source volume by copying whole data in the source volume at the time of receipt of the OPC instruction and storing the data as a snapshot (backup data).

In order to support such technologies, there is a case where a data image is divided into fixed sections and it is recorded whether or not copy is completed for each of the sections. Such data indicating whether or not copy is completed is called a copy bitmap or a differential bitmap.

The copy bitmap is created by dividing a copy source volume into unit regions of a predetermined size (for example, 8 KB) and associating each of the unit regions with information indicating whether or not data stored in the unit region has been transferred to a copy destination volume.

In the storage apparatus, the data constituting the copy bitmap is stored in a memory that provides fast data access, and OPC is performed while referring to and updating the copy bitmap.

A related technique is disclosed in, for example, Japanese Laid-open Patent Publication No. 2006-331100.

In recent years, an increase in disk drive capacity in the storage apparatus has increased an available data capacity. Such an increase in volume size also increases the size of the copy bitmap.

In a conventional storage apparatus, since the copy bitmap is held in the memory as described above, the increase in the size of the copy bitmap strains the memory capacity, leading to a problem that memory shortage may occur.

### SUMMARY

According to an aspect of the present invention, provided is a storage control apparatus including a processor. The processor is configured to store partial progress information in a memory. The partial progress information is a part of progress information units of a predetermined size. The progress information units are obtained by dividing whole progress information stored in a storage device different from the memory. The whole progress information indicates progress of copy processing of copying data stored in a copy source region to a copy destination region. The processor is configured to perform the copy processing on basis of the partial progress information stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a storage system according to an embodiment;

FIG. 2 is a diagram illustrating a copy bitmap and on-cache bitmaps in a storage system according to an embodiment;

FIG. 3 is a diagram illustrating a copy bitmap and a represent bitmap in a storage system according to an embodiment;

FIG. 4 is a diagram illustrating a management link in a storage system according to an embodiment;

FIG. 5 is a diagram illustrating rearrangement of on-cache bitmaps in a management link in a storage system according to an embodiment;

FIG. 6 is a diagram illustrating basic processing while performing OPC in a storage system according to an embodiment;

FIG. 7 is a diagram illustrating basic processing while performing OPC in a storage system according to an embodiment;

FIG. 8 is a diagram illustrating basic processing while performing OPC in a storage system according to an embodiment;

FIG. 9 is a diagram illustrating basic processing while performing OPC in a storage system according to an embodiment;

FIG. 10 is a diagram illustrating basic processing while performing OPC in a storage system according to an embodiment;

FIG. 11 is a diagram illustrating processing when I/O occurs while performing OPC in a storage system according to an embodiment;

FIG. 12 is a diagram illustrating processing when I/O occurs while performing OPC in a storage system according to an embodiment;

FIG. 13 is a diagram illustrating processing when I/O occurs while performing OPC in a storage system according to an embodiment;

FIG. 14 is a diagram illustrating processing when I/O occurs while performing OPC in a storage system according to an embodiment;

FIG. 15 is a diagram illustrating processing when I/O occurs while performing OPC in a storage system according to an embodiment;

FIG. 16 is a diagram illustrating processing when I/O occurs while performing OPC in a storage system according to an embodiment;

FIG. 17 is a diagram illustrating processing when I/O occurs while performing OPC in a storage system according to an embodiment;

FIG. 18 is a flowchart illustrating OPC processing in a storage system according to an embodiment;

FIG. 19 is a flowchart illustrating processing when an I/O request is received from a host device while performing OPC in a storage system according to an embodiment;

FIG. 20 is a diagram illustrating processing of multiple OPC sessions in a storage system according to an embodiment;

FIG. 21 is a diagram illustrating a modified example of a system configuration of a storage system according to an embodiment;

FIG. 22 is a diagram illustrating processing during data copy by ROPC and processing during write into an ROPC range regarding a copy source storage apparatus and a copy destination storage apparatus in a storage system according to an embodiment; and

FIG. 23 is a diagram illustrating processing in case of a network failure during ROPC processing in a storage system according to an embodiment.

### DESCRIPTION OF EMBODIMENT

Hereinafter, with reference to the drawings, an embodiment related to a storage control apparatus and a storage system is described. The following embodiment is for illustrative purposes only, and not intended to exclude applications of various modified examples and technologies not specified in the embodiment. More specifically, the embodiment may be implemented by making various modifications (such as combining the embodiment and modified examples) without departing from the scope thereof. The drawings may include other functions and the like rather than including only the constituent elements illustrated in the drawings.

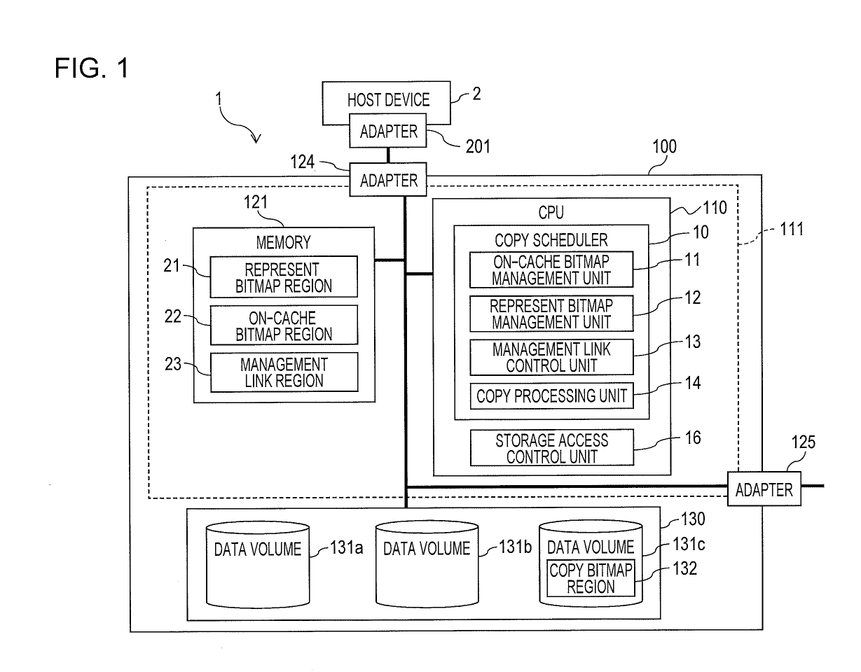

FIG. 1 is a diagram illustrating an exemplary configuration of a storage system 1 according to the embodiment.

As illustrated in FIG. 1, the storage system 1 according to the embodiment includes a storage apparatus 100 and a host device 2.

In the example illustrated in FIG. 1, the host device 2 as a higher-level device is connected to the storage apparatus 100.

The host device 2 is an information processing apparatus, and is, for example, a computer including a central processing unit (CPU), a random access memory (RAM), a read-only memory (ROM) and the like, which are not illustrated in FIG. 1. The host device 2 includes an adapter 201. The adapter 201 is connected to an adapter 124, which is included in the storage apparatus 100, through a communication line.

The host device 2 writes and reads data into and from volumes 131a, 131b, and 131c in the storage apparatus 100 connected thereto. For example, the host device 2 makes a data access request (input/output request: I/O request), such as read and write, to the copy source volume 131a that is an operation volume in the storage apparatus 100. The storage apparatus 100 performs a data access to the copy source volume 131a in response to the data access request and responds to the host device 2.

The host device 2 also performs creation of session information about a copy session in the storage apparatus 100.

The session information is information concerning a copy session, including a session identifier (ID), a logical unit number (LUN) and a start logical block address (LBA) of a copy source, and a LUN, a start LBA, and a block count (BC) of a copy destination. The session information may be created using a known method.

The session information created by the host device 2 is transmitted to the storage apparatus 100 and held in a memory 121 or the like in the storage apparatus 100.

The storage apparatus 100 provides the host device 2 with a storage area, and is a redundant array of inexpensive disks (RAID) apparatus, for example. Note that, for convenience, FIG. 1 illustrates a state where one host device 2 is connected to the storage apparatus 100. However, two or more host devices may be connected to the storage apparatus 100.

As illustrated in FIG. 1, the storage apparatus 100 includes a controller module (CM) 111 and a storage device 130. The storage device 130 is a hard disk drive (HDD) or a solid state drive (SSD), for example, and has a data capacity larger than that of a RAM in the memory 121. In the storage apparatus 100, storage areas of the storage device 130 is allocated to data volumes.

In the example illustrated in FIG. 1, the data volumes 131a, 131b, and 131c are formed in the storage device 130.

As described later, the storage system 1 has a data copy function to copy data in one data volume (logical volume) included in the storage apparatus 100 by transferring the data to another data volume.

Hereinafter, description is given of an example of data copy where data stored in the data volume 131a is stored into the data volume 131b. More specifically, the data volume 131a corresponds to a copy source region, while the data volume 131b corresponds to a copy destination region. Hereinafter, the data volume 131a may be called the copy source volume 131a, while the data volume 131b may be called a copy destination volume 131b.

A part of the storage area of the storage device 130 (in the example illustrated in FIG. 1, a part of the data volume 131c) is used as a copy bitmap region 132.

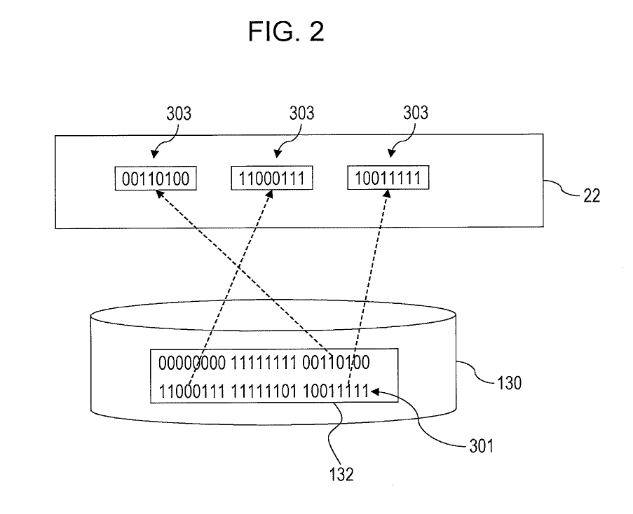

In the copy bitmap region 132, a copy bitmap 301 (see FIG. 2) is stored.

The copy bitmap 301 is created, for example, by dividing the copy source volume into multiple unit regions of a predetermined size (for example, 8 KB) and associating each of the unit regions with information indicating whether or not data stored in the unit region is transferred (copied) to the copy destination volume. In other words, the copy bitmap 301 is progress information indicating the progress of copy from the copy source region to the copy destination region.

A copy processing unit 14 to be described later uses the copy bitmap 301 to manage the progress of copy, copy results, and the like, during the copy from the copy source volume 131a to the copy destination volume 131b.

FIG. 2 is a diagram illustrating the copy bitmap 301 and on-cache bitmaps 303 in the storage system 1 according to the embodiment.

As illustrated in FIG. 2, the copy bitmap 301 uses a 1-bit value to manage whether or not to copy a region of a predetermined size in the copy source volume 131a. As for the 1 bit, the value “1” is set when data in the corresponding region is not yet copied, that is, has to be copied. On the other hand, the value “0” is set when the data in the corresponding region has been copied, that is, does not have to be copied.

Accordingly, the copy bitmap 301 functions as the progress information indicating the progress of the copy from the copy source region to the copy destination region. The copy bitmap 301 is a bit string in which each bit represents the progress of the copy from the copy source region to the copy destination region with “0” or “1”.

The storage device 130 including the copy bitmap region 132 to store the copy bitmap 301 functions as a first storage unit to store the progress information.

The CM 111 performs various kinds of control in the storage apparatus 100, such as access control to the data volumes 131a, 131b, and 131c in the storage device 130 in accordance with a storage access request (access control signal) from the host device 2 that is a higher-level apparatus.

As illustrated in FIG. 1, the CM 111 includes the memory 121, a CPU 110, the adapter 124, and an adapter 125. In the example illustrated in FIG. 1, the storage apparatus 100 includes one CM 111. However, the embodiment is not limited thereto, but the storage apparatus 100 may include two or more CMs 111.

The adapter 124 is an interface controller which communicably connects to the host device 2, and is connected to the adapter 201 in the host device 2 through the communication line. The adapter 124 is a network adapter or a fibre channel adapter, for example.

When an operator, for example, uses the host device 2 to instruct data copy from the copy source volume 131a to the copy destination volume 131b, the adapter 124 functions as a reception unit to receive the data copy instruction.

The adapter 125 is an interface controller which communicably connects to another storage apparatus 100 or the like through a line (not illustrated).

The memory 121 is a storage memory including a ROM and a RAM.

As illustrated in FIG. 1, some parts of the RAM in the memory 121 are used as a represent bitmap region 21, an on-cache bitmap region 22, and a management link region 23.

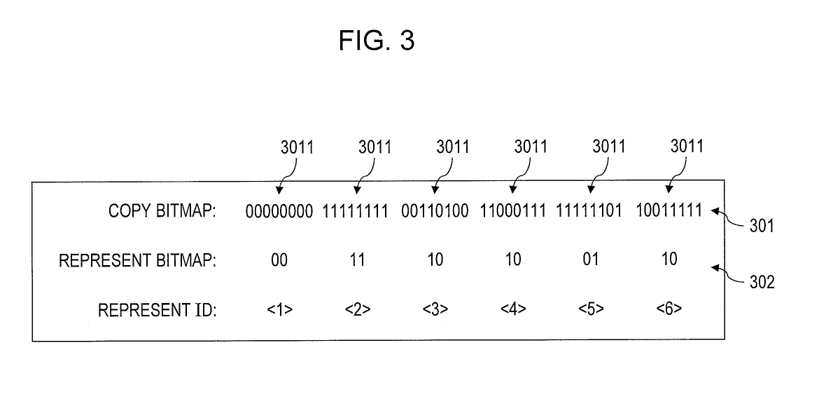

In the on-cache bitmap region 22, unit copy bitmaps 3011 (see FIG. 3) corresponding to parts of the copy bitmap 301 stored in the storage device 130 (the copy bitmap region 132) are stored (set) as the on-cache bitmaps 303.

The unit copy bitmaps 3011 correspond to bit strings formed by dividing the copy bitmap 301 into units of a predetermined size (represent size). A unit copy bitmap 3011 is created by copying a consecutive bit string of the represent size in the copy bitmap 301.

Hereinafter, for convenience, creating the unit copy bitmaps 3011 by copying the bit strings formed by dividing the copy bitmap 301 into units of the predetermined size (represent size) is simply expressed as creating the unit copy bitmaps 3011 by dividing the copy bitmap 301.

FIG. 2 illustrates an example of the on-cache bitmaps 303 of the unit copy bitmaps 3011 created by dividing the copy bitmap 301 into 8-bit units.

In the storage system 1, a part of the copy bitmap 301 stored in the storage device 130 is stored as the unit copy bitmaps 3011 in the on-cache bitmap region 22 of the memory 121. The memory 121 generally provides faster data access than an HDD. Thus, fast access to the unit copy bitmaps 3011 may be performed by storing the unit copy bitmaps 3011 in the on-cache bitmap region 22 of the memory 121.

Hereinafter, the unit copy bitmaps 3011 in the on-cache bitmap region 22 may be referred to as the on-cache bitmaps 303.

In the example illustrated in FIG. 2, three on-cache bitmaps 303 “00110100”, “11000111”, and “10011111” are stored in the on-cache bitmap region 22.

In the represent bitmap region 21, a represent bitmap 302 (see FIG. 3) is stored. The represent bitmap 302 is state information indicating the states of the bit strings within a predetermined range in the copy bitmap 301. In the represent bitmap 302, each of the states of the consecutive bit strings of the predetermined size (represent size) in the copy bitmap 301 is represented by a value of the number of bits smaller than the represent size.

FIG. 3 is a diagram illustrating the copy bitmap 301 and the represent bitmap 302 in the storage system 1 according to the embodiment.

FIG. 3 illustrates the represent bitmap 302 corresponding to the unit copy bitmaps 3011.

FIG. 3 illustrates an example of unit copy bitmaps 3011 created by dividing the copy bitmap 301 into 8-bit units. In the storage system 1, each of the states of the unit copy bitmaps 3011 is represented by a 2-bit value, as illustrated in FIG. 3, in the represent bitmap 302.

To be more specific, when all the bits included in a unit copy bitmap 3011 are “0”, “00” is set as a value in the represent bitmap 302. In other words, the value “00” in the represent bitmap 302 indicates that an entire unit copy source region corresponding to the unit copy bitmap 3011 has been copied.

When all the bits included in a unit copy bitmap 3011 are “1”, “11” is set as a value in the represent bitmap 302. In other words, the value “11” in the represent bitmap 302 indicates that an entire unit copy source region corresponding to the unit copy bitmap 3011 is not yet copied.

When “0”s and “1”s are mixed as the bits included in a unit copy bitmap 3011 and the unit copy bitmap 3011 is stored in the on-cache bitmap region 22 of the memory 121, “10” is set as a value in the represent bitmap 302. In other words, the value “10” in the represent bitmap 302 indicates that not-yet-copied regions and already-copied regions are mixed in a unit copy source region corresponding to the unit copy bitmap 3011 and that the unit copy bitmap 3011 is set in the on-cache bitmap region 22 of the memory 121.

When “0”s and “1”s are mixed as the bits included in a unit copy bitmap 3011 and the unit copy bitmap 3011 is not stored in the on-cache bitmap region 22 of the memory 121, “01” is set as a value in the represent bitmap 302. In other words, the value “01” in the represent bitmap 302 indicates that not-yet-copied regions and already-copied regions are mixed in a unit copy source region corresponding to the unit copy bitmap 3011 and that the unit copy bitmap 3011 is not set in the on-cache bitmap region 22 of the memory 121.

Hereinafter, portions corresponding to the unit copy bitmaps 3011 in the represent bitmap 302 are expressed by identification information (represent IDs), respectively. FIG. 3 illustrates the represent IDs below the respective values included in the represent bitmap 302. FIG. 3 illustrates an example using integers (1 to 6) as the represent IDs, and each of these numbers is enclosed in the signs “<” and “>”.

As described above, the represent bitmap 302 represents the states of the respective unit copy bitmaps 3011 stored in the memory 121. Thus, it may be said that the represent IDs correspond to the respective unit copy bitmaps 3011.

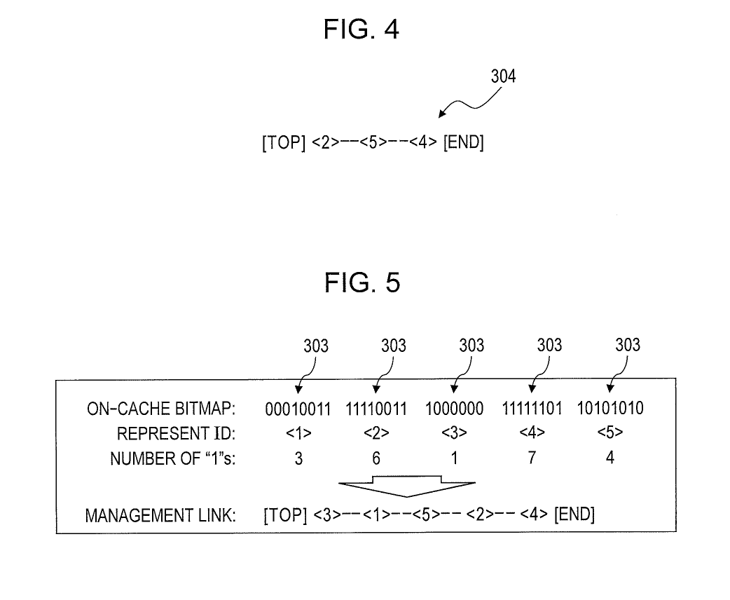

In the management link region 23, a management link 304 (see FIG. 4) is stored. The management link 304 is information concerning the on-cache bitmaps 303 (unit copy bitmaps 3011) in the on-cache bitmap region 22 of the memory 121.

In the management link 304, a position of an on-cache bitmap 303 held in the memory 121 is associated with information on a position in the copy bitmap region 132 of the storage device 130 and a range in the data volume 131c, which correspond to the on-cache bitmap 303.

The management link 304 manages the unit copy bitmaps 3011 to be processed as a queue. By link control, the unit copy bitmaps 3011 to be processed are arranged and managed in the order of preferential processing by a copy scheduler 10 (see FIG. 1) to be described later.

FIG. 4 is a diagram illustrating the management link 304 in the storage system 1 according to the embodiment.

In the management link 304 illustrated in FIG. 4, the processing order of the unit copy bitmaps 3011 (on-cache bitmaps 303) is represented using the represent IDs. More specifically, the on-cache bitmaps 303 to be processed are arranged in the processing order between a character string “[TOP]” and a character string “[END]”. In the example illustrated in FIG. 4, three on-cache bitmaps 303 represented by the represent IDs 2, 5, and 4 are registered in the management link 304, and this link indicates that the unit copy bitmaps 3011 are to be processed in the order of the represent IDs 2, 5, and 4.

Data to be copied from the copy source volume 131a to the copy destination volume 131b, for example, is temporarily stored in a predetermined region in the RAM in the memory 121. Thus, the memory 121 functions as a copy buffer memory.

Furthermore, data received from the host device 2 and data to be transmitted to the host device 2 are temporarily stored in another predetermined region in the RAM in the memory 121. Thus, the memory 121 also functions as a buffer memory.

Moreover, in yet another predetermined region in the RAM in the memory 121, data and programs are temporarily stored and developed while the CPU 110 to be described later executes the programs.

In the ROM in the memory 121, software programs (for example, a storage control program and a copy control program) related to control as a storage control apparatus and data for these programs are written. The software programs on the memory 121 are appropriately read and executed by the CPU 110. The RAM in the memory 121 is also used as a primary storage memory or a working memory.

The CPU 110 is a processing unit configured to perform various controls and operations, and realizes various functions by executing the programs stored in the memory 121 and the like.

As illustrated in FIG. 1, the CPU 110 functions as the copy scheduler 10 and a storage access control unit 16. For example, the CPU 110 realizes the function of the copy scheduler 10 by executing the copy control program, while realizes the function of the storage access control unit 16 by executing the storage control program.

The above-described programs to realize the functions of the copy scheduler 10 and the storage access control unit 16 are provided in the form of being recorded in a computer-readable recording medium such as a flexible disk, a compact disc (CD) such as CD-ROM, CD-R, and CD-RW, a digital versatile disc (DVD) such as DVD-ROM, DVD-RAM, DVD-R, DVD+R, DVD-RW, DVD+RW, and HD DVD, a Blu-ray disc, a magnetic disk, an optical disk, and a magneto-optical disk, for example. The computer uses the programs by reading the programs from such a recording medium and then transferring and storing the programs to and in an internal storage device or an external storage device. The program may be recorded in a storage device (recording medium) such as a magnetic disk, an optical disk, and a magneto-optical disk, for example, and provided to the computer from the storage device through a communication path.

The storage access control unit 16 controls data access to the storage device 130 (data volumes 131a, 131b, and 131c), and performs data write and read into and from the storage device 130. For example, the storage access control unit 16 writes data into the copy source volume 131a in response to a write access request from the host device 2, and sends a completion response to the host device 2.

The function of the storage access control unit 16 may be realized using known various methods, and detailed description thereof is omitted.

The copy scheduler 10 realizes the above-described data copy function to copy data in one data volume (for example, the copy source volume 131a) included in the storage apparatus 100 by transferring the data to another data volume (for example, the copy destination volume 131b).

As illustrated in FIG. 1, the copy scheduler 10 includes functions of an on-cache bitmap management unit 11, a represent bitmap management unit 12, a management link control unit 13, and the copy processing unit 14.

The copy processing unit 14 performs copy processing (OPC) on the basis of the copy bitmap 301 (unit copy bitmap 3011, on-cache bitmap 303) described above. More specifically, the copy processing unit 14 copies (overwrites) a data block of the copy source volume 131a corresponding to a bit having “1” set in the copy bitmap 301 (unit copy bitmap 3011, on-cache bitmap 303) in a corresponding region in the copy destination volume 131b.

Here, the OPC is a function to create a clone of a volume, and performs initial copy to copy data from the copy source volume 131a to the copy destination volume 131b beginning with the top of the data. In the OPC, when there is write into an not-yet-copied region, data in the copy region where the write is to be performed is preferentially copied to the copy destination volume 131b.

In the storage system 1, the copy bitmap 301 for managing the state of the entire copy region is held in a region of the storage device 130 having a capacity larger than that of the memory 121.

The on-cache bitmap management unit 11 performs control to store (set) a part (the unit copy bitmap 3011) of the copy bitmap 301, which desires detailed access, as an on-cache bitmap 303, in the on-cache bitmap region 22 of the memory 121 having a high access speed.

An upper limit is set beforehand on the number (capacity) of the on-cache bitmaps 303 stored in the on-cache bitmap region 22 of the memory 121. The on-cache bitmap management unit 11 manages the on-cache bitmaps 303 in the on-cache bitmap region 22 until the upper limit is exceeded. The unit copy bitmap 3011 in the portion exceeding the upper limit is not stored in the on-cache bitmap region 22, and the copy processing unit 14 uses the copy bitmap 301 in the storage device 130.

As described above, “10” is set as a value in the represent bitmap 302 for a unit copy bitmap 3011 which is stored in the on-cache bitmap region 22 and has “0”s and “1”s mixed as the bits included therein. When “0”s and “1”s are mixed as the bits included in a unit copy bitmap 3011 and the unit copy bitmap 3011 is not stored in the on-cache bitmap region 22 of the memory 121, “01” is set as a value in the represent bitmap 302.

The on-cache bitmap management unit 11 releases the on-cache bitmap 303, for which the copy processing is completed by the copy processing unit 14, from the on-cache bitmap region 22.

The represent bitmap management unit 12 manages the represent bitmap 302. The represent bitmap management unit 12 secures the represent bitmap region 21 on the memory 121. The represent bitmap management unit 12 uses 2-bit values to represent the state of the copy bitmap 301 in the copy bitmap region 132 of the storage device 130, for each predetermined represent size range (unit copy bitmap 3011), in the represent bitmap region 21. More specifically, the represent bitmap management unit 12 creates the represent bitmap 302.

When all the bits included in a unit copy bitmap 3011 are “0”, the represent bitmap management unit 12 sets “00” as a value in the represent bitmap 302. When all the bits included in a unit copy bitmap 3011 are “1”, the represent bitmap management unit 12 sets “11” as a value in the represent bitmap 302. When “0”s and “1”s are mixed as the bits included in a unit copy bitmap 3011 and the unit copy bitmap 3011 is stored in the on-cache bitmap region 22 of the memory 121, the represent bitmap management unit 12 sets “10” as a value in the represent bitmap 302. When “0”s and “1”s are mixed as the bits included in a unit copy bitmap 3011 and the unit copy bitmap 3011 is not stored in the on-cache bitmap region 22 of the memory 121, the represent bitmap management unit 12 sets “01” as a value in the represent bitmap 302.

The management link control unit 13 manages the management link 304.

In the storage system 1, when the copy scheduler 10 starts OPC, copy is performed sequentially from the top region in the copy source volume 131a by the initial copy processing.

However, for a region for which an on-cache bitmap 303 is registered in the management link 304, the copy processing unit 14 uses the on-cache bitmap 303 to preferentially perform copy.

For example, when a page of the copy bitmap 301 is switched during the initial copy processing, the management link control unit 13 checks the management link 304 before processing of the next page. When an on-cache bitmap 303 is registered in the management link 304, a region corresponding to the on-cache bitmap 303 is preferentially copied.

Since an on-cache bitmap 303, for which copy processing is completed, is released from the memory 121, the memory 121 may be efficiently used.

The on-cache bitmaps 303 which exceed a capacity set as the on-cache bitmap region 22 are not managed on the memory 121. Therefore, depending on the size of the on-cache bitmap region 22, there is a limit to the number of on-cache bitmaps 303 (represent bitmap 302) to be registered in the management link 304.

According to the embodiment, the number of on-cache bitmaps 303 to be registered in the management link 304 is obtained by subtracting 1 from the maximum number of on-cache bitmaps 303 (unit copy bitmaps 3011) to be held in the on-cache bitmap region 22.

The reason for subtracting 1 is to ensure one spare region to be used as a region to temporarily store an on-cache bitmap 303 in case that a unit copy bitmap 3011 has to be read from the copy bitmap 301 in the storage device 130 during depletion of the management link region 23.

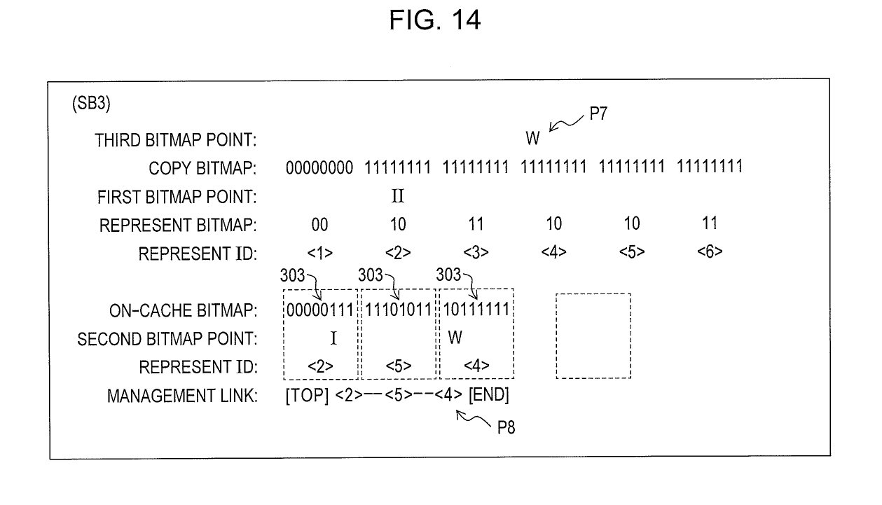

For example, in FIG. 14, three regions to store on-cache bitmaps 303 are indicated by dashed squares, and in addition, a spare region is indicated by a dashed square.

In this example, a state where the on-cache bitmaps 303 are linked in the management link 304 to the maximum number (for example, 3) may be called a MAX state of the management link 304.

The management link control unit 13 also includes a function to rearrange the on-cache bitmaps 303 registered in the management link 304.

More specifically, the management link control unit 13 rearranges the multiple on-cache bitmaps 303 registered in the management link 304 so that one having fewer “1”s as the bits included in each on-cache bitmap 303 is to be preferentially processed.

FIG. 5 is a diagram illustrating rearrangement of on-cache bitmaps 303 in the management link 304 in the storage system 1 according to the embodiment.

In the example illustrated in FIG. 5, five on-cache bitmaps 303 having represent IDs “1” to “5” are illustrated. For example, an on-cache bitmap 303 having the represent ID “1” includes five “0”s and three “1”s. Therefore, the number of “1”s included in the on-cache bitmap 303 having the represent ID “1” is 3.

Likewise, the numbers of “1”s included in the on-cache bitmaps 303 having the represent IDs “2” to “5” are 6, 1, 7, and 4, respectively.

Therefore, when the on-cache bitmaps 303 having the represent IDs “1” to “5” are arranged in ascending order of the number of “1”s, the order of the represent IDs is “3”, “1”, “5”, “2”, and “4” as illustrated in FIG. 5.

As described above, the management link control unit 13 rearranges the on-cache bitmaps 303 linked in the management link 304 so that one having fewer “1”s as the bits included in each on-cache bitmap 303 is to be preferentially processed.

The rearrangement in the management link 304 may be performed at any timing, for example, periodically or in a state where the CPU 110 is low on load (the load is not more than a predetermined threshold). Thus, the rearrangement may be performed in various modified manners.

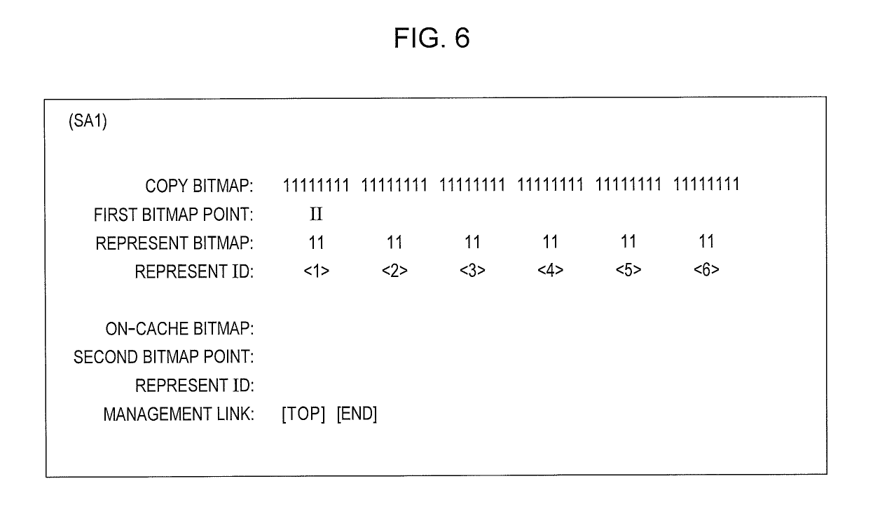

With reference to FIGS. 6 to 10, description is given of basic processing (processing SA1 to SA5) while performing OPC in the storage system 1, which is configured as described above, according to the embodiment. FIGS. 6 to 10 are diagrams each illustrating the copy bitmap 301, the represent bitmap 302, the on-cache bitmaps 303 and the management link 304 in each process.

Each copy bitmap illustrated in FIGS. 6 to 10 represents the copy bitmap 301 stored in the copy bitmap region 132 of the storage device 130.

In FIGS. 6 to 10, a represent bitmap 302 for a unit copy bitmap 3011 corresponding to data which is being copied by the copy processing unit 14, in the copy bitmap 301, is represented by a first bitmap point. According to the embodiment, a symbol “II” represents the first bitmap point, as illustrated in FIG. 6. For example, in FIG. 6, the first bitmap point indicates a portion corresponding to the unit copy bitmap 3011 having the represent ID “1” in the represent bitmap 302.

Referring to the first bitmap point makes it possible to find out the value of the represent bitmap 302 for a unit copy bitmap 3011 in processing.

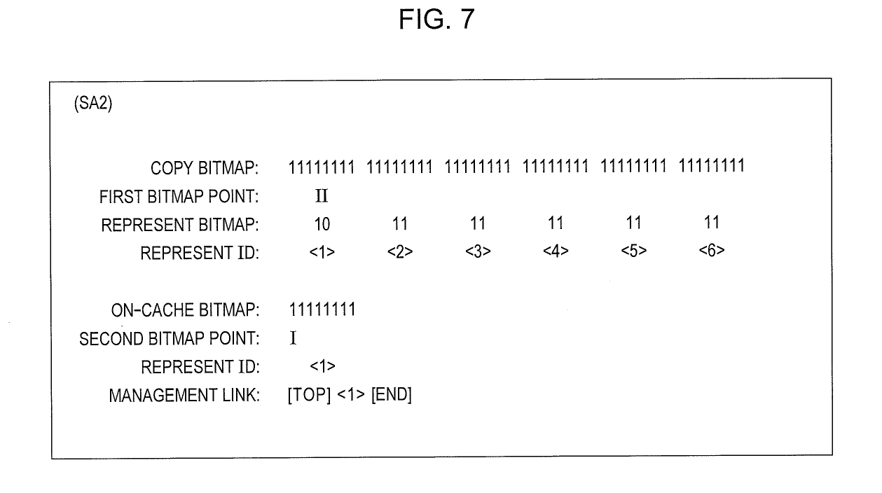

In FIGS. 6 to 10, a second bitmap point represents a position (bit position), where copy is being performed by the copy processing unit 14, in the on-cache bitmap 303. According to the embodiment, a symbol “I” represents the second bitmap point as illustrated in FIG. 7. For example, in FIG. 7, the second bitmap point indicates the top bit in the on-cache bitmap 303 having the represent ID “1”.

(SA1) First, as illustrated in FIG. 6, when the copy scheduler 10 performs an OPC session, the copy processing unit 14 allocates the copy bitmap 301 to the copy bitmap region 132 of the storage device 130, and writes (sets) “1”s into the whole copy bitmap 301.

The represent bitmap management unit 12 initializes the represent bitmap 302 in the represent bitmap region 21 in the memory 121 by setting “11”s into the whole represent bitmap 302.

In the example illustrated in FIG. 6, an initial state is illustrated where no on-cache bitmap 303 is stored in the on-cache bitmap region 22 and no on-cache bitmap 303 is registered in the management link 304.

(SA2) The copy processing unit 14 starts copy processing by setting the first bitmap point at the top 2 bits in the represent bitmap 302.

In the example illustrated in FIG. 6 described above, the value at the top (the represent ID “1”) of the represent bitmap 302 is “11”. Thus, the region of the unit copy bitmap 3011 having the represent ID “1” is allocated to the on-cache bitmap region 22 of the memory 121. Then, initialization is performed by setting “1”s in all the bits in the region having the represent ID “1” in the allocated on-cache bitmap region 22.

Thus, as illustrated in FIG. 7, an on-cache bitmap 303 having the represent ID “1” is stored in the on-cache bitmap region 22. Therefore, the represent bitmap management unit 12 changes the value in the portion corresponding to the represent ID “1” in the represent bitmap 302 to “10”.

Thereafter, the on-cache bitmap 303 having the represent ID “1” is set in the management link 304. Hereinafter, setting an on-cache bitmap 303 (unit copy bitmap 3011) in the management link 304 may be referred to as linking to the management link 304. Moreover, deleting the on-cache bitmap 303 (unit copy bitmap 3011) from the management link 304 may be referred to as unlinking from the management link 304.

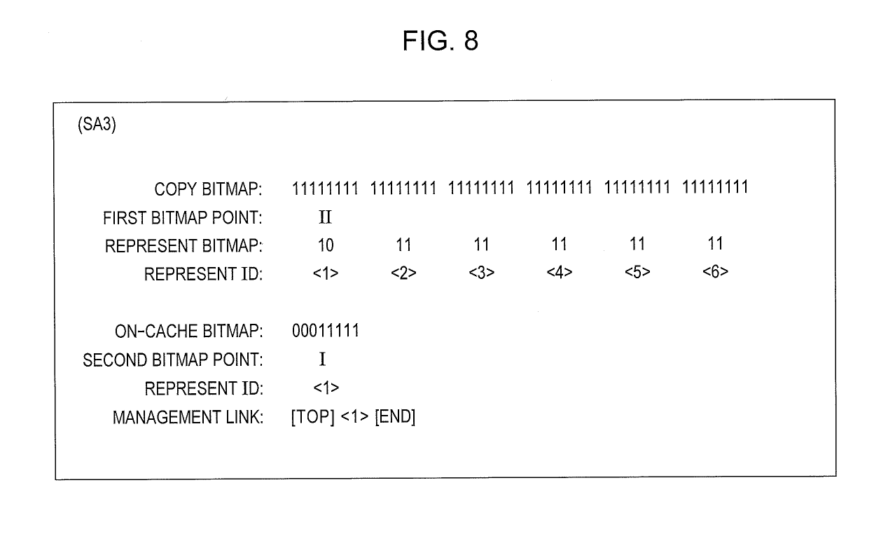

(SA3) The copy processing unit 14 performs copy processing while moving the second bitmap point forward on the on-cache bitmap 303. An example illustrated in FIG. 8 illustrates a state where the copy processing unit 14 is performing copy processing of a region corresponding to the fourth bit from the top of the on-cache bitmap 303 having the represent ID “1”.

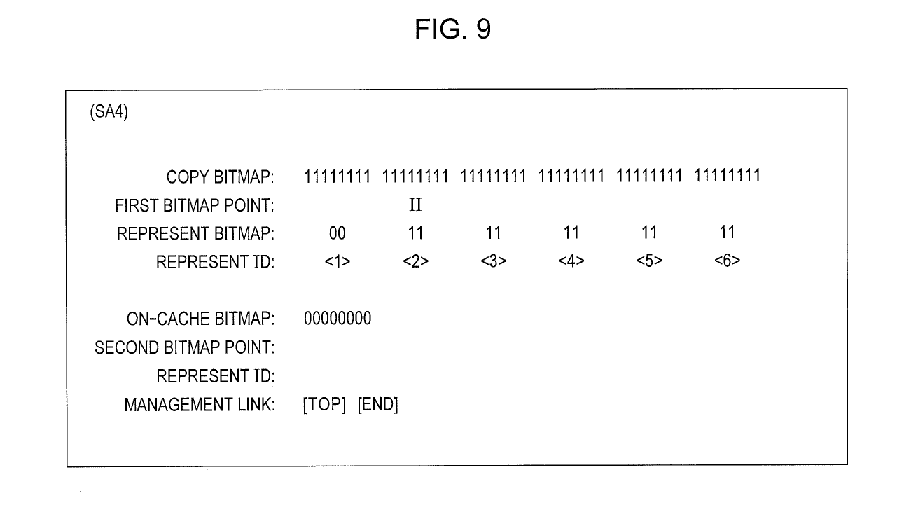

(SA4) In an example illustrated in FIG. 9, the copy processing of the on-cache bitmap 303 having the represent ID “1” is completed by repeatedly performing the copy processing, and all the bits are set to “0”.

Accordingly, the represent bitmap management unit 12 changes the represent bitmap 302 corresponding to the represent ID “1” to “00”. The management link control unit 13 also unlinks the represent bitmap 302 corresponding to the represent ID “1” from the management link 304.

Thereafter, the copy processing unit 14 rewrites all the bits in a portion, which corresponds to the represent ID “1”, in the copy bitmap 301 in the storage device 130 to “0”, in accordance with the on-cache bitmap 303. Thus, the copy bitmap 301 in the storage device 130 is synchronized with the on-cache bitmap 303 in the memory 121.

The copy processing unit 14 sets (moves) the first bitmap point to the next position in the represent bitmap 302.

(SA5) Thereafter, the copy processing unit 14 similarly performs the copy processing for the unit copy bitmaps 3011 having the represent IDs “2” and the following numbers in the copy bitmap 301.

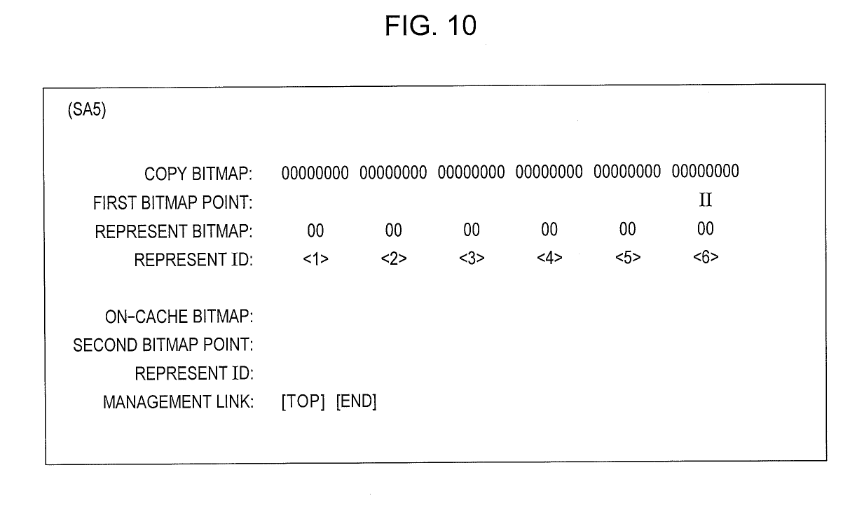

The above processing is repeatedly performed unless a data I/O request to a not-yet-copied region arrives from the host device 2. Then, as illustrated in FIG. 10, the OPC is completed when the values in the whole represent bitmap 302 are set to “00”.

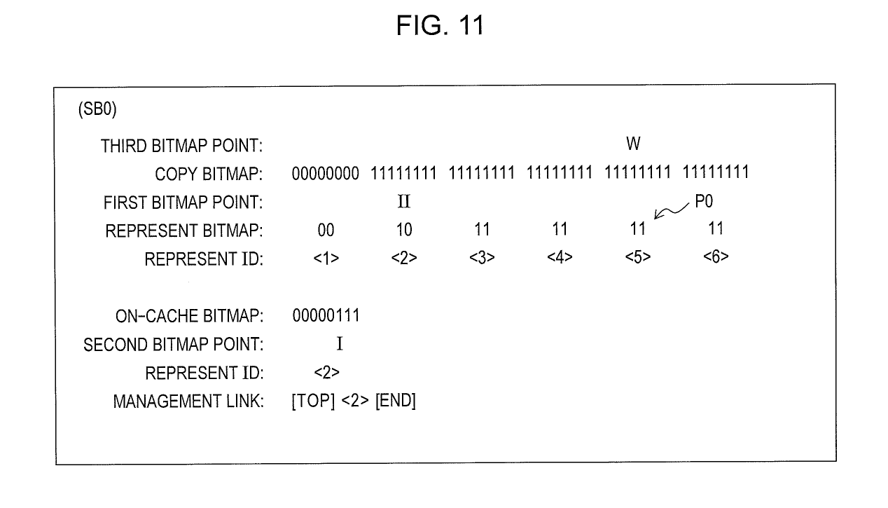

Next, with reference to FIGS. 11 to 17, description is given of processing (processing SB0 to SB6) when I/O occurs while performing OPC in the storage system 1, which is configured as described above, according to the embodiment. FIGS. 11 to 17 are diagrams each illustrating the copy bitmap 301, the represent bitmap 302, the on-cache bitmaps 303, and the management link 304 in each process.

Each copy bitmap illustrated in FIGS. 11 to 17 represents the copy bitmap 301 stored in the copy bitmap region 132 of the storage device 130. A first bitmap point represents a unit copy bitmap 3011 corresponding to data which is being copied by the copy processing unit 14, in the copy bitmap 301. A second bitmap point represents a position (bit position) where copy is being performed by the copy processing unit 14, in the on-cache bitmap 303.

Furthermore, in FIGS. 11 to 17, a third bitmap point represents a position (bit position), in the copy bitmap 301, for which a write request (I/O request) is received from the host device 2. According to the embodiment, a symbol “W” represents the third bitmap point, as illustrated in FIG. 11. For example, in FIG. 11, the third bitmap point indicates the fourth bit from the top of the unit copy bitmap 3011 having the represent ID “5”.

(SB0) In the example illustrated in FIG. 11, OPC for the unit copy bitmap 3011 (on-cache bitmap 303) having the represent ID “2”, in the copy bitmap 301, is being performed. Only the on-cache bitmap 303 having the represent ID “2” is stored in the on-cache bitmap region 22 and the management link 304.

Then, it is assumed that, while the OPC is performed, a write request (host write) is issued from the host device 2 for the fourth bit from the top of the unit copy bitmap 3011 having the represent ID “5”. Hereinafter, a unit copy bitmap 3011 corresponding to a target region of a host write request may be simply referred to as a target unit copy bitmap 3011 of host write.

(SB1) In the example illustrated in FIG. 11, the value of the target unit copy bitmap 3011 of host write in the represent bitmap 302 is “11” (P0 in FIG. 11).

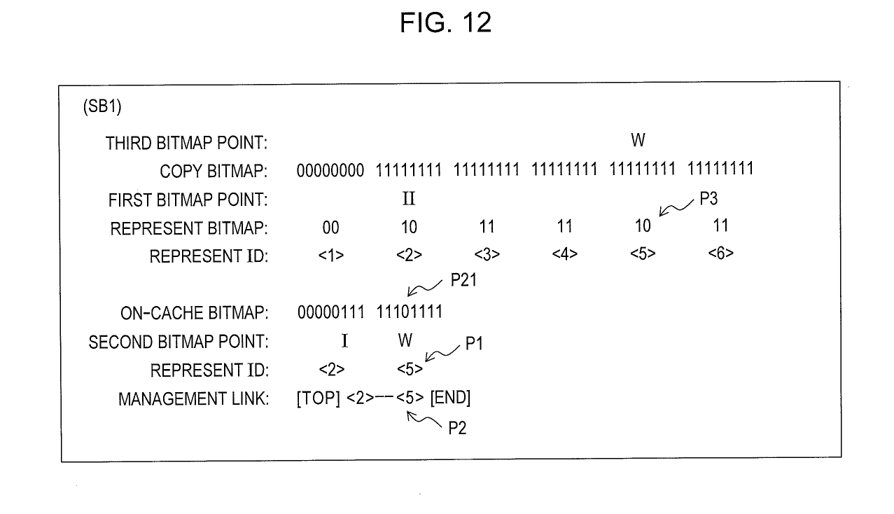

In this case, as illustrated in FIG. 12, the on-cache bitmap management unit 11 allocates a region of the unit copy bitmap 3011 having the represent ID “5” that is the target unit copy bitmap 3011 of host write to the on-cache bitmap region 22 (P1 in FIG. 12). Then, the on-cache bitmap management unit 11 performs initialization by setting “1” in the entire region allocated. Thus, the unit copy bitmap 3011 (on-cache bitmap 303) having the represent ID “5” is set (stored) in the on-cache bitmap region 22.

Moreover, the management link control unit 13 links the unit copy bitmap 3011 (on-cache bitmap 303) having the represent ID “5” to the management link 304 (P2 in FIG. 12).

The copy processing unit 14 copies data corresponding to the target unit copy bitmap 3011 of host write from the copy source volume 131a to the copy destination volume 131b. Then, the storage access control unit 16 performs host write in the target region.

Then, the on-cache bitmap management unit 11 updates the fourth bit from the top of the on-cache bitmap 303 having the represent ID “5” to “0” (P21 in FIG. 12).

The represent bitmap management unit 12 updates the value of the represent bitmap 302 corresponding to the target unit copy bitmap 3011 of host write to “10” (P3 in FIG. 12).

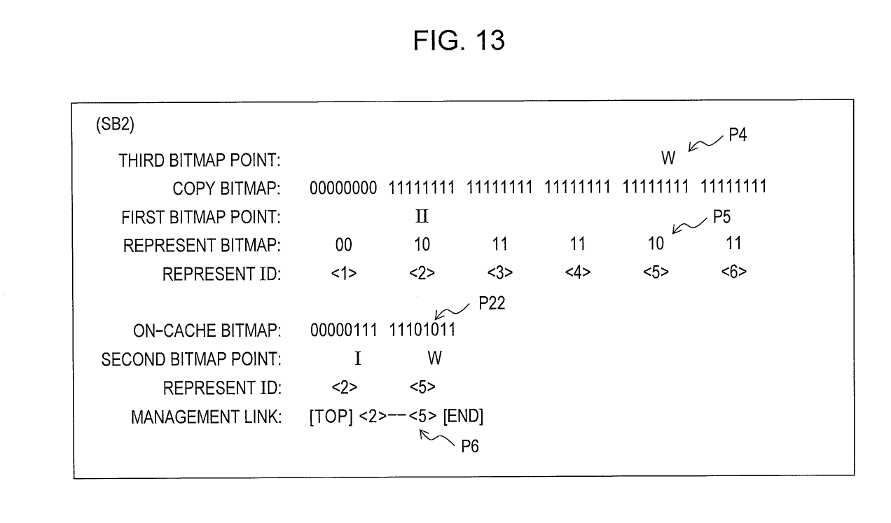

(SB2) Next, it is assumed that, as illustrated in FIG. 13, another host write is issued. In the example illustrated in FIG. 13, the host write is issued for the sixth bit from the top of the unit copy bitmap 3011 having the represent ID “5” (P4 in FIG. 13).

At this time, the value of the represent bitmap 302 corresponding to the target unit copy bitmap 3011 of host write is “10” (P5 in FIG. 13). As described above, when the value in the represent bitmap 302 is “10”, the unit copy bitmap 3011 is stored in the on-cache bitmap region 22 of the memory 121 (the region of the unit copy bitmap 3011 has been allocated).

Then, the copy processing unit 14 obtains the position of the on-cache bitmap 303 having the represent ID “5” in the on-cache bitmap region 22 of the memory 121 by referring to the management link 304 (P6 in FIG. 13).

The copy processing unit 14 refers to the on-cache bitmap 303 having the represent ID “5” to perform OPC of data corresponding to the host write target region in the on-cache bitmap 303. After the OPC, the storage access control unit 16 performs write processing corresponding to the host write.

Thereafter, the on-cache bitmap management unit 11 updates the sixth bit from the top of the on-cache bitmap 303 having the represent ID “5” to “0” (P22 in FIG. 12).

(SB3) Furthermore, it is assumed that, as illustrated in FIG. 14, another host write is issued. In the example illustrated in FIG. 14, the host write is issued for the second bit from the top of the unit copy bitmap 3011 having the represent ID “4” (P7 in FIG. 14).

When a host write is issued, as described above, for a new unit copy bitmap 3011 which is not linked to the management link 304, as in the case of the above processing (SB1), the management link control unit 13 links the unit copy bitmap 3011 (on-cache bitmap 303) having the represent ID “4” to the management link 304 (P8 in FIG. 14).

In the example illustrated in FIG. 14, two on-cache bitmaps 303 having the represent IDs “2” and “5”, respectively, are previously linked to the management link 304, and another on-cache bitmap 303 having the represent ID “4” is further linked to the management link 304.

In the storage system 1, the maximum number of the on-cache bitmaps 303 to be linked to the management link 304 is 3. Therefore, the management link 304 is in the full linked state (MAX state).

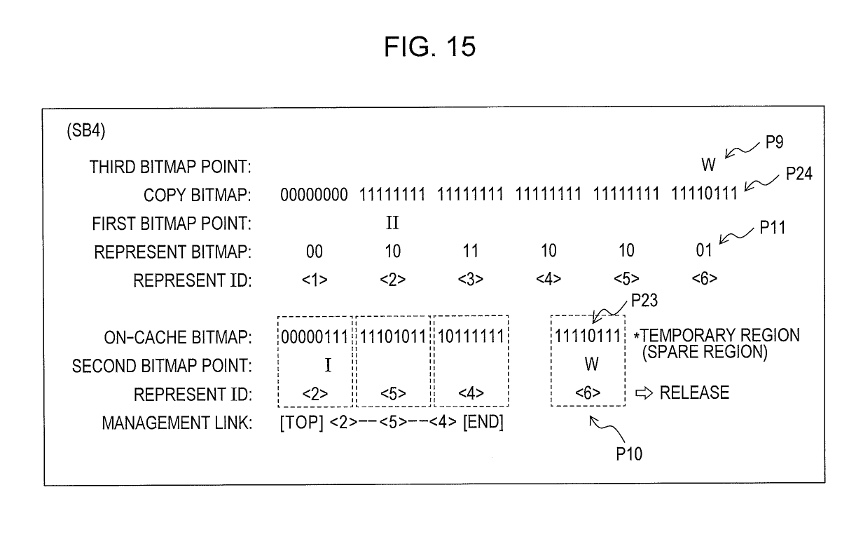

(SB4) Furthermore, it is assumed that, as illustrated in FIG. 15, another host write is issued. In the example illustrated in FIG. 15, the host write is issued for the fifth bit from the top of the unit copy bitmap 3011 having the represent ID “6” (P9 in FIG. 15).

Since three, which is the maximum number, on-cache bitmaps 303 are already linked to the management link 304, the unit copy bitmap 3011 having the represent ID “6” is registered in a spare region in the management link 304 (P10 in FIG. 15).

The copy processing unit 14 refers to the on-cache bitmap 303 having the represent ID “6” to perform OPC of data corresponding to the host write target region in the on-cache bitmap 303.

After the OPC for the on-cache bitmap 303 having the represent ID “6”, the storage access control unit 16 performs write processing corresponding to the host write.

Thereafter, the on-cache bitmap management unit 11 updates the fifth bit from the top of the on-cache bitmap 303 having the represent ID “6” to “0” (P23 in FIG. 15).

When the management link 304 is in the MAX state, the management link control unit 13 writes the on-cache bitmap 303 stored in the spare region back into the copy bitmap region 132 of the storage device 130. In other words, the copy bitmap 301 in the storage device 130 is updated using the on-cache bitmap 303 having the represent ID “6” (P24 in FIG. 15).

Thereafter, the on-cache bitmap management unit 11 deletes the on-cache bitmap 303, which has been written back, from the on-cache bitmap region 22. In other words, the on-cache bitmap 303 is released from the memory 121.

At the same time, the represent bitmap management unit 12 updates the value of the represent bitmap 302 corresponding to the on-cache bitmap 303 to “01” (P11 in FIG. 15).

(SB5) When the OPC processing advances in the state illustrated in FIG. 15 and the copy of the on-cache bitmap 303 having the represent ID “2” is completed, the processing normally advances to the unit copy bitmap 3011 having the represent ID “3” which follows the represent ID “2” in the copy bitmap 301.

However, in the storage system 1, when another represent ID is registered subsequent to the represent ID “2” in the management link 304, the copy processing unit 14 preferentially performs copy processing for an on-cache bitmap 303 having the subsequently registered represent ID in the management link 304.

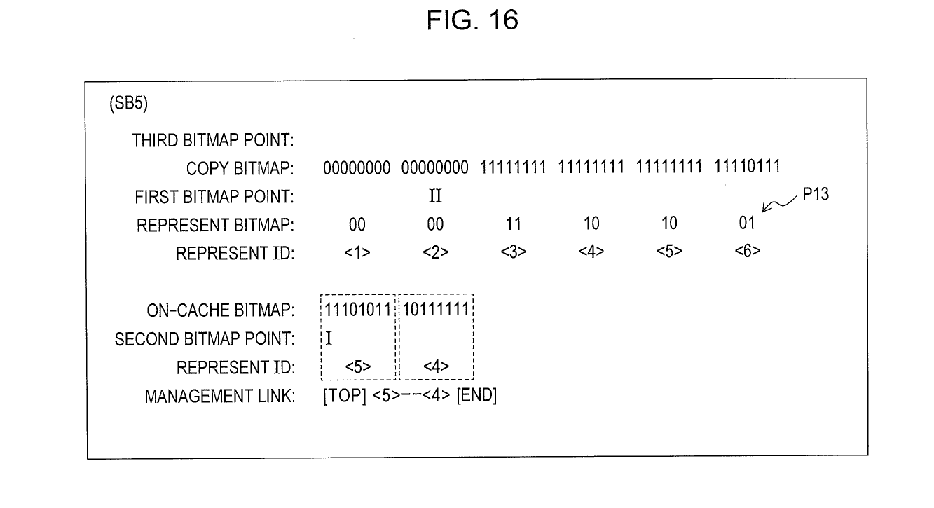

In the example illustrated in FIG. 16, the on-cache bitmap 303 having the represent ID “5” registered at the top of the management link 304 is processed prior to the unit copy bitmap 3011 having the represent ID “3” which follows the represent ID “2” in the copy bitmap 301.

Thus, vacancies in the memory 121 are increased by actively reducing the number of on-cache bitmaps 303 held in the memory 121 (on-cache bitmap region 22). More specifically, the processing performance is kept from being degraded by depletion of the on-cache bitmap region 22 for storing the on-cache bitmaps 303 in the memory 121 and data write back into the storage device 130.

The original OPC schedule position (first bitmap point) in the copy bitmap 301 is stored in a predetermined storage region such as the memory 121.

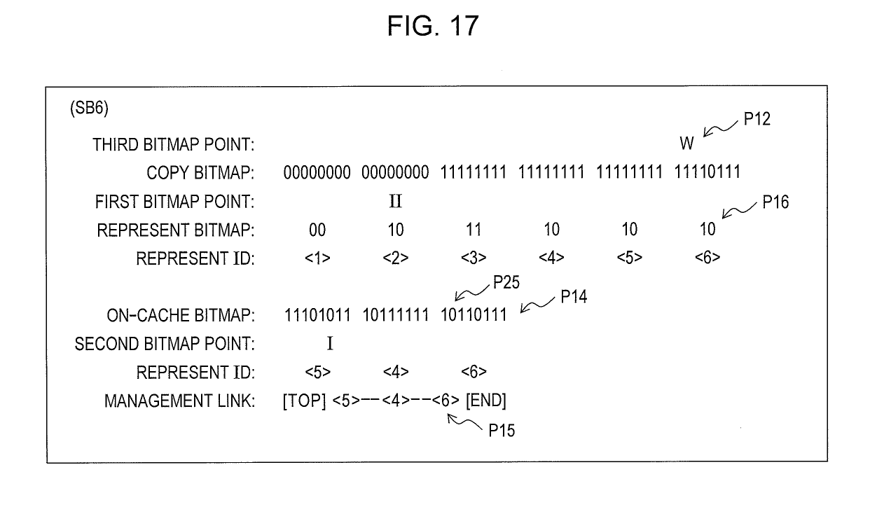

(SB6) Next, it is assumed that, as illustrated in FIG. 17, another host write is issued. In the example illustrated in FIG. 17, the host write is issued for the second bit from the top of the unit copy bitmap 3011 having the represent ID “6” (P12 in FIG. 17).

In the state illustrated in FIG. 16, the value of the unit copy bitmap 3011 having the represent ID “6”, which is the host write target, in the represent bitmap 302 is “01” (P13 in FIG. 16). As described above, when the value in the represent bitmap 302 is “01”, the unit copy bitmap 3011 is not stored in the on-cache bitmap region 22 of the memory 121 (the region of the unit copy bitmap 3011 is not yet allocated).

Therefore, as illustrated in FIG. 17, the on-cache bitmap management unit 11 reads the unit copy bitmap 3011 having the represent ID “6” from the copy bitmap 301 stored in the copy bitmap region 132 of the storage device 130, and stores the read unit copy bitmap 3011 in the on-cache bitmap region 22 of the memory 121 (P14 in FIG. 17).

Since there is a vacancy in the management link 304 in the state illustrated in FIG. 16, the management link control unit 13 links the on-cache bitmap 303 having the represent ID “6” to the management link 304 (P15 in FIG. 17).

Thereafter, the represent bitmap management unit 12 changes the value corresponding to the unit copy bitmap 3011 having the represent ID “6” in the represent bitmap 302 to “10” (P16 in FIG. 17).

The copy processing unit 14 refers to the on-cache bitmap 303 having the represent ID “6” to perform OPC of data corresponding to the host write target region in the on-cache bitmap 303. After the OPC, the storage access control unit 16 performs write processing corresponding to the host write.

Thereafter, the on-cache bitmap management unit 11 updates the second bit from the top of the on-cache bitmap 303 having the represent ID “6” to “0” (P25 in FIG. 17).

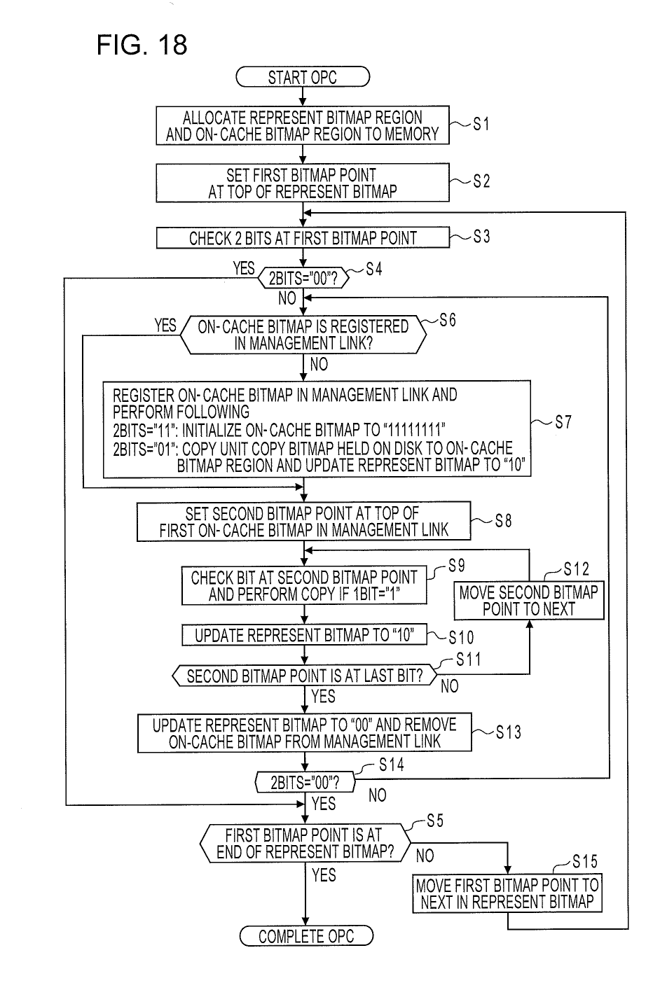

Next, with reference to a flowchart illustrated in FIG. 18, description is given of OPC processing in the storage system 1, which is configured as described above, according to the embodiment.

In S1, the represent bitmap management unit 12 allocates the represent bitmap region 21 to the memory 121. The on-cache bitmap management unit 11 also allocates the on-cache bitmap region 22 to the memory 121.

In S2, the represent bitmap management unit 12 sets a bitmap point (first bitmap point) at the top of the represent bitmap 302.

In S3, the represent bitmap management unit 12 checks a 2-bit value indicated by the first bitmap point.

In S4, it is checked whether a 2-bit value (denoted by “2BITS” in FIG. 18) indicated by the first bitmap point is “00”. When the 2-bit value indicated by the first bitmap point is “00” (Yes in S4), the represent bitmap management unit 12 determines that copy is not required, and the processing proceeds to S5.

In S5, the represent bitmap management unit 12 checks whether the first bitmap point is at the end of the represent bitmap 302.

When the first bitmap point is at the end of the represent bitmap 302 (Yes in S5), it is determined that OPC is completed, and thus the processing is terminated.

When the first bitmap point is not at the end of the represent bitmap 302 (No in S5), the processing proceeds to S15.

In S15, the first bitmap point is moved forward by 1 (for 2 bits) in the represent bitmap 302. Thereafter, the processing returns to S3.

When the 2-bit value indicated by the first bitmap point in the represent bitmap 302 is not “00” (No in S4) as a result of the checking in S4, the processing proceeds to S6.

In S6, it is checked whether an on-cache bitmap 303 is registered in the management link 304. When an on-cache bitmap 303 is registered in the management link 304 (Yes in S6), the processing proceeds to S8.

In S8, the second bitmap point is set at the top of the first on-cache bitmap 303 in the management link 304.

When no on-cache bitmap 303 is registered in the management link 304 (No in S6), the processing proceeds to S7.

In S7, the management link control unit 13 registers an on-cache bitmap 303 in the management link 304. Also, the following processing is performed according to the 2-bit value indicated by the first bitmap point in the represent bitmap 302 checked in S3.

More specifically, when the 2-bit value indicated by the first bitmap point in the represent bitmap 302 is “11”, initialization is performed by writing “1” in all the bits of the registered on-cache bitmap 303.

When the 2-bit value indicated by the first bitmap point in the represent bitmap 302 is “01”, a unit copy bitmap 3011 at the position corresponding to the first bitmap point is copied to the on-cache bitmap region 22 from the copy bitmap 301 held in the storage device 130. Moreover, the value at the position of the first bitmap point in the represent bitmap 302 is updated to “10”, and the processing proceeds to S8.

In S9, a 1-bit value (denoted by “1BIT” in FIG. 18) at the position indicated by the second bitmap point in the on-cache bitmap 303 is checked. If the 1-bit value is “1”, the copy processing unit 14 copies data in a region corresponding to the bit from the copy source volume 131a to the copy destination volume 131b, that is, the copy processing unit 14 performs OPC.

In S10, the value at the position of the first bitmap point in the represent bitmap 302 is updated to “10”. In S11, it is checked whether the second bitmap point is at the end of the on-cache bitmap 303 in processing.

When the second bitmap point is not at the end of the on-cache bitmap 303 in processing (No in S11), the processing returns to S9 after the second bitmap point is moved to the next in S12.

When the second bitmap point is at the end of the on-cache bitmap 303 in processing (Yes in S11), the processing proceeds to S13.

In S13, the value at the position of the first bitmap point in the represent bitmap 302 is updated to “00”, and the processed on-cache bitmap 303 is unlinked from the management link 304.

In S14, it is checked whether the 2-bit value indicated by the first bitmap point in the represent bitmap 302 is “00”. When the on-cache bitmap 303 at the top of the management link 304 set in S8 is not the on-cache bitmap 303 corresponding to the 2-bit value indicated by the first bitmap point in the represent bitmap 302, the represent bitmap 302 to be updated in S13 is the on-cache bitmap 303 at the top of the management link 304, and the 2-bit value indicated by the first bitmap point in the represent bitmap 302 may not be “00” at the time of S14. When the 2-bit value indicated by the first bitmap point in the represent bitmap 302 is not “00” (No in S14), the processing returns to S6. The on-cache bitmap 303 at the top of the management link 304 is processed again in S8, and the processing of the on-cache bitmaps 303 in the management link 304 is continued until the 2-bit value indicated by the first bitmap point in the represent bitmap 302 becomes “00”.

When the 2-bit value indicated by the first bitmap point in the represent bitmap 302 is “00” (Yes in S14), the processing proceeds to S5.

In S5, the represent bitmap management unit 12 checks whether the first bitmap point is at the end of the represent bitmap 302.

When the first bitmap point is not at the end of the represent bitmap 302 (No in S5), the first bitmap point is moved forward by 1 (for 2 bits) in the represent bitmap 302 in S15. Thereafter, the processing returns to S3.

When the first bitmap point is at the end of the represent bitmap 302 (Yes in S5), it is determined that OPC is completed, and thus the processing is terminated.

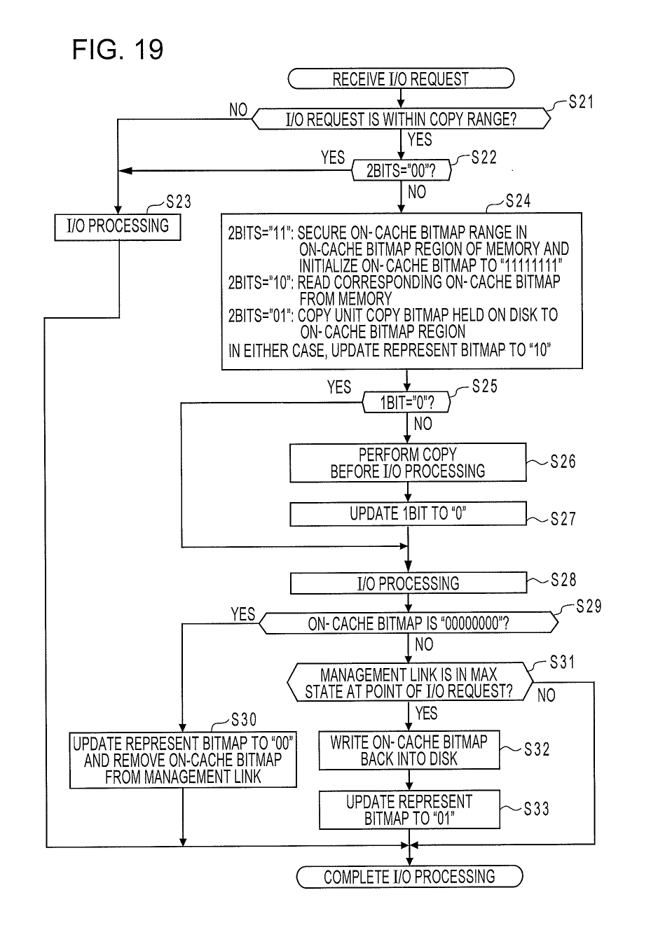

Next, with reference to a flowchart illustrated in FIG. 19, description is given of processing when an I/O request is received from the host device 2 while performing OPC in the storage system 1 according to the embodiment.

In the storage system 1, when an I/O request is received from the host device 2, it is first checked in S21 whether the I/O request is within a copy range of the OPC.

When the I/O request is not within the copy range of the OPC (No in S21), the processing proceeds to S23. In S23, the I/O request received from the host device 2 is processed. In other words, data read and write from and to the data volumes 131a, 131b, and 131c are performed. When the processing of the I/O request is completed, the processing is terminated.

When the I/O request is within the copy range of the OPC (Yes in S21), the processing proceeds to S22. In S22, the represent bitmap management unit 12 checks whether a 2-bit value (denoted by “2BITS” in FIG. 19) in the represent bitmap 302 corresponding to the region for which the I/O request is received from the host device 2 is “00”.

When the 2-bit value in the represent bitmap 302 is “00” as a result of the checking (Yes in S22), the represent bitmap management unit 12 determines that copy is not required, and the processing proceeds to S23. In S23, the I/O request received from the host device 2 is processed, and then the processing is terminated.

As described above, when the 2-bit value in the represent bitmap 302 is “00”, it means that all the bits included in the corresponding unit copy bitmap 3011 are “0”. In other words, for the region for which the I/O request is received from the host device 2, copy processing by OPC is not required or copy processing by OPC is already completed. Therefore, the processing may be completed without checking the copy bitmap 301 in the copy bitmap region 132 by accessing the storage device 130.

When the 2-bit value in the represent bitmap 302 is not “00” (No in S22) as a result of the checking, the processing proceeds to S24.

In S24, the following processing is performed depending on the 2-bit value in the represent bitmap 302 checked in S22.

As described above, the 2-bit value “11” in the represent bitmap 302 means that all the bits included in the corresponding unit copy bitmap 3011 are “1”.

Therefore, the on-cache bitmap management unit 11 secures a range as an on-cache bitmap 303 in the on-cache bitmap region 22, and then writes “1”s in all the bits within the secured range. Thus, the on-cache bitmap 303 corresponding to the region for which the I/O request is received from the host device 2 is created in the on-cache bitmap region 22. At this time, no access occurs to the storage device 130.

As described above, the 2-bit value “10” in the represent bitmap 302 means that “0”s and “1”s are mixed in the bits included in a unit copy bitmap 3011 and the unit copy bitmap 3011 is stored in the on-cache bitmap region 22 of the memory 121.

Therefore, when the 2-bit value in the represent bitmap 302 is “10”, the on-cache bitmap management unit 11 reads the on-cache bitmap 303 corresponding to the region, for which the I/O request is received from the host device 2, from the on-cache bitmap region 22. At this time, no access occurs to the storage device 130.

As described above, the 2-bit value “01” in the represent bitmap 302 means that “0”s and “1”s are mixed in the bits included in a unit copy bitmap 3011 and the unit copy bitmap 3011 is not stored in the on-cache bitmap region 22 of the memory 121.

Therefore, when the 2-bit value in the represent bitmap 302 is “01”, the on-cache bitmap management unit 11 accesses the storage device 130 to read a unit copy bitmap 3011 in the copy bitmap region 132 and copy the unit copy bitmap 3011 to the on-cache bitmap region 22. Thus, the on-cache bitmap 303 corresponding to the region for which the I/O request is received from the host device 2 is created in the on-cache bitmap region 22. At this time, access to the storage device 130 occurs.

Thereafter, regardless of the 2-bit value in the represent bitmap 302, processing is performed to update the 2-bit value in the corresponding region in the represent bitmap 302 to “10”.

Furthermore, in S24, the management link control unit 13 registers the created on-cache bitmap 303 in the management link 304.

At this time, when the management link 304 is already in the MAX state, the on-cache bitmap 303 is registered in the spare region in the management link 304.

Thereafter, in S25, the on-cache bitmap management unit 11 checks whether a 1-bit value (denoted by “1BIT” in FIG. 19) at the position, in the on-cache bitmap 303 created in S24, for which the I/O request is received from the host device 2 is “0”.

When the 1-bit value at the position, in the on-cache bitmap 303, for which the I/O request is received from the host device 2 is not “0” (No in S25), the processing proceeds to S26. In S26, the copy processing unit 14 copies the data in the region corresponding to the bit from the copy source volume 131a to the copy destination volume 131b, that is, the copy processing unit 14 performs OPC.

In S27, the on-cache bitmap management unit 11 updates the 1-bit value at the position, which corresponds to the region where the copy processing is performed in S26 by the copy processing unit 14, in the on-cache bitmap 303 to “0”. Thereafter, the processing proceeds to S28.

When the 1-bit value at the position, in the on-cache bitmap 303, for which the I/O request is received from the host device 2 is “0” (Yes in S25), the processing proceeds to S28.

In S28, the storage access control unit 16 processes the I/O request from the host device 2.

In S29, the on-cache bitmap management unit 11 checks whether values of all the bits in the on-cache bitmap 303 created in S24 are “0”.

When the values of all the bits in the on-cache bitmap 303 are “0” (Yes in S29), the processing proceeds to S30. In S30, the value at the position corresponding to the on-cache bitmap 303 in the represent bitmap 302 is updated to “00”, and the processed on-cache bitmap 303 is unlinked from the management link 304. When this processing is completed, the processing is terminated.

When values of some bits in the on-cache bitmap 303 are not “0” (No in S29) as a result of the checking in S29, the processing proceeds to S31. In S31, it is checked whether the management link 304 is in the MAX state when the I/O request is received from the host device 2.

When the management link 304 is not in the MAX state when the I/O request is received from the host device 2 (No in S31), the processing is terminated.

When the management link 304 is in the MAX state when the I/O request is received from the host device 2 (Yes in S31), the processing proceeds to S32. In S32, the on-cache bitmap 303 stored in the spare region is written back to the copy bitmap region 132 of the storage device 130.

Thereafter, the on-cache bitmap management unit 11 deletes the on-cache bitmap 303, which has been written back, from the on-cache bitmap region 22. In other words, the on-cache bitmap 303 is released from the memory 121.

In S33, the represent bitmap management unit 12 updates the 2-bit value in the represent bitmap 302 corresponding to the on-cache bitmap 303 to “01”. Thereafter, the processing is terminated.

As described above, in the storage system 1 according to the embodiment, the copy bitmap 301 is stored in the copy bitmap region 132 of the storage device 130 having a data capacity larger than that of the memory 121, instead of the memory 121. Thus, the usage of the memory 121 may be reduced. Also, even when the size of the copy source volume 131a is increased, no memory shortage occurs.

The represent bitmap region 21 is created on the memory 121, and the represent bitmap 302 is stored in the represent bitmap region 21. The represent bitmap 302 indicates states of consecutive bit strings (unit copy bitmaps 3011) of the represent size in the copy bitmap 301.

Therefore, the copy bitmap 301 is stored in the large-capacity storage device 130 such as an HDD, and the state of the copy bitmap 301 (unit copy bitmaps 3011) is managed with 2-bit information in the form of the represent bitmap 302 in the memory 121. Thus, copy processing may be performed while saving the memory region for a copy session with a large copy capacity.

The 2-bit information of the represent bitmap 302 represents any of the following states.

“00”: all the bits included in a unit copy bitmaps 3011 are 0

“11”: all the bits included in a unit copy bitmaps 3011 are 1

“01”: “0”s and “1”s are mixed in a unit copy bitmaps 3011 and the unit copy bitmaps 3011 is not held in the on-cache bitmap region 22 of the memory 121.

“10”: “0”s and “1”s are mixed in a unit copy bitmaps 3011 and the unit copy bitmaps 3011 is held in the on-cache bitmap region 22 of the memory 121.

The copy processing unit 14 performs OPC while referring to the represent bitmap 302. At this time, no disk access occurs when the value in the represent bitmap 302 is other than “01”.

As described above, while the OPC is performed, undesired access to the storage device 130 may be suppressed by referring to the represent bitmap 302. Moreover, there is not much influence even if the copy bitmap 301 is stored in the storage device 130 which provides slower data access than the memory 121.

When the 2-bit information of the represent bitmap 302 is “00”, OPC is not required since the entire region of the corresponding unit copy bitmap 3011 has been copied. In other words, no disk access to the storage device 130 occurs.

When the 2-bit information of represent bitmap 302 is “11”, the on-cache bitmap 303 may be reproduced by initialization to “1” since the entire region of the corresponding unit copy bitmap 3011 is not yet copied. Therefore, the copy bitmap 301 does not have to be read and copied from the copy bitmap region 132 of the storage device 130. Thus, no disk access to the storage device 130 occurs.

When the 2-bit information of represent bitmap 302 is “10”, since there is an on-cache bitmap 303 on the memory 121 (on-cache bitmap region 22), the copy processing unit 14 may perform OPC using the on-cache bitmap 303. Therefore, the copy bitmap 301 does not have to be read and copied from the copy bitmap region 132 of the storage device 130. Thus, no disk access to the storage device 130 occurs.

When the 2-bit information of represent bitmap 302 is “01”, there is no corresponding unit copy bitmap 3011 on the memory 121. Therefore, the corresponding unit copy bitmap 3011 has to be copied to the on-cache bitmap region 22 from the copy bitmap 301 held in the copy bitmap region 132 of the storage device 130. In this case, disk access to the storage device 130 occurs.

Moreover, the memory 121 may be quickly released since the management link control unit 13 manages the on-cache bitmap 303 using the management link 304. More specifically, the on-cache bitmap 303 to be processed is managed as a queue in the management link 304, and the top of the queue in the management link 304 is preferentially processed by OPC. Thus, the memory 121 may be efficiently used by releasing the on-cache bitmap 303 after the OPC is completed from the memory 121.

Furthermore, the management link control unit 13 rearranges the queue in the management link 304. To be more specific, the management link control unit 13 performs the rearrangement such that an on-cache bitmap 303 having fewer “1”s, which indicate that the corresponding data is not yet copied or required to be copied, is preferentially processed. Thus, an on-cache bitmap 303 in a state where the on-cache bitmap 303 may be released from the memory 121 with a little more copy is preferentially performed, and vacancies may be efficiently secured in the memory 121 (on-cache bitmap region 22). As a result, the memory region may be saved while maintaining copy performance.

Moreover, by placing a unit copy bitmap 3011 that is being updated as the on-cache bitmap 303 on the memory 121, disk accesses to the storage device 130 may be reduced. Thus, the memory region may be saved while maintaining the copy performance.

Furthermore, the memory region may be saved while maintaining the copy performance since the management link control unit 13 manages the processing priority with a link and writing back a low-priority one onto a disk.

Embodiments are not limited to the one described above, but may be implemented by making various modifications without departing from the spirit thereof.

For example, in the above embodiment, the description is given of the example where one OPC session is processed. However, the embodiment is not limited thereto but is also applicable to a case where multiple OPC sessions are processed in parallel.

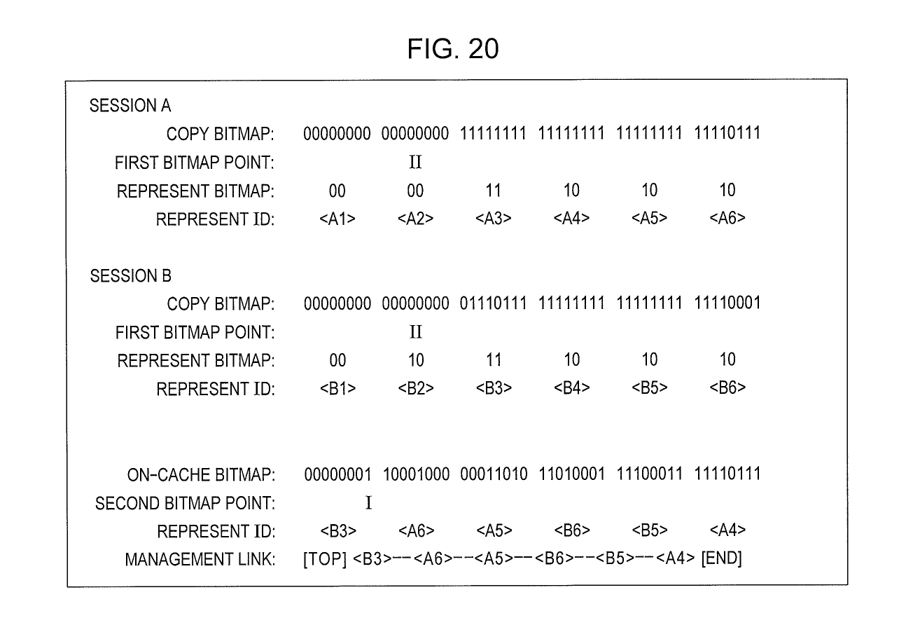

FIG. 20 is a diagram illustrating processing of multiple OPC sessions in the storage system 1 according to another embodiment.

In the example illustrated in FIG. 20, description is given of a case where a session A to perform copy from the data volume 131a to the data volume 131b and a session B to perform copy from the data volume 131b to the data volume 131c are processed in parallel.

In FIG. 20, represent IDs related to the session A are indicated by “A1” to “A6”, while represent IDs related to the session B are indicated by “B1” to “B6”.

When multiple sessions are simultaneously performed as described above, a copy bitmap region 132 is provided for each session in the storage device 130, and a copy bitmap 301 is stored for each session in the corresponding copy bitmap region 132.

As for the represent bitmap 302, a represent bitmap region 21 is provided for each session in the memory 121, and a represent bitmap 302 is stored for each session in the corresponding represent bitmap region 21. More specifically, the represent bitmap management unit 12 manages the represent bitmap 302 for each session.

As illustrated in FIG. 20, a first bitmap point is also provided in each represent bitmap 302 for each session.

On the other hand, as for the on-cache bitmap 303, on-cache bitmaps 303 for the respective sessions are stored in a mixed state in the on-cache bitmap region 22 of the memory 121.

The on-cache bitmap management unit 11 manages the on-cache bitmaps 303 for more than one session in the mixed state in the on-cache bitmap region 22. When referring to the on-cache bitmaps 303 in the on-cache bitmap region 22, the on-cache bitmap management unit 11 calculates an address of the corresponding on-cache bitmap 303 on the basis of information in the management link 304.

As described above, by sharing the on-cache bitmap region 22 among the multiple sessions, the region used in the memory 121 may be reduced and management is facilitated.

As for the management link 304, the management link control unit 13 manages the management link 304 for more than one session in the mixed state of the on-cache bitmaps 303. In other words, the management link control unit 13 manages the management link 304 by linking the on-cache bitmaps 303 for the multiple sessions to one management link 304 in the mixed state.

As described above, the multiple sessions are managed using one management link 304 to perform processing of rearranging the on-cache bitmaps 303 in the management link 304. Such integration of the sessions A and B facilitates release of the on-cache bitmaps 303 from the memory 121.

When an on-cache bitmap 303 is linked to the management link 304, normal OPC schedules for the sessions A and B are both stopped to preferentially perform processing of the on-cache bitmaps 303 linked to the management link 304.

In the above-described embodiment, the description is given of the example where OPC is performed from the copy source volume 131a to the copy destination volume 131b, which are included in the same storage apparatus 100. However, embodiments are not limited thereto.

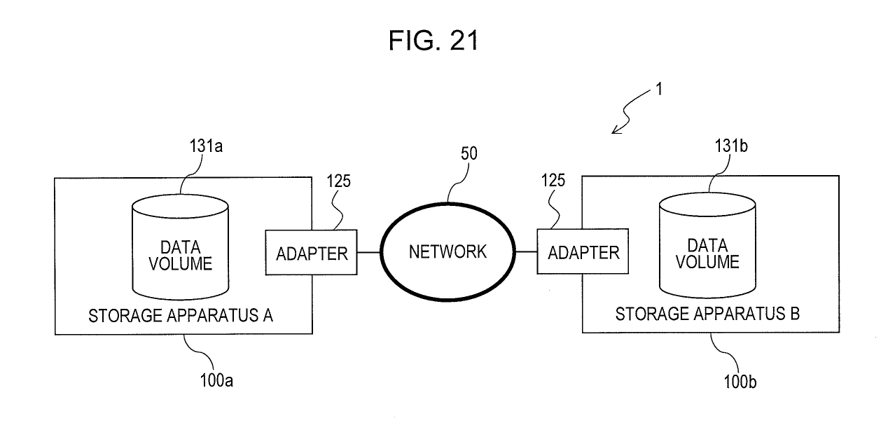

FIG. 21 is a diagram illustrating a modified example of the system configuration of the storage system 1 according to the embodiment.

In the modified example illustrated in FIG. 21, a storage apparatus 100a and a storage apparatus 100b are communicably connected to each other through a network 50.

The storage apparatuses 100a and 100b both have similar configurations to that of the storage apparatus 100 described above. Hereinafter, the storage apparatus 100a may be referred to as a storage apparatus A, while the storage apparatus 100b may be referred to as a storage apparatus B.

The storage apparatuses 100a and 100b are connected to the network 50 through adapters 125, respectively.

The storage apparatuses 100a and 100b as illustrated in FIG. 21 may be connected through the network 50 and applied to data copy, such as remote OPC (ROPC), between the storage apparatuses 100a and 100b.

As described above, the storage apparatuses 100a and 100b both have similar configurations as that of the storage apparatus 100 illustrated in FIG. 1. For example, in each of the storage apparatuses 100a and 100b, a represent bitmap region 21, an on-cache bitmap region 22, and a management link region 23 are provided in a memory 121, and a copy bitmap region 132 is provided in a storage device 130. Settings thereof, for example, a bitmap size (bitmap granularity) and the like have to be set to the same in both of the storage apparatuses 100a and 100b.

Hereinafter, description is given of a case where ROPC of data is performed from a data volume 131a (copy source volume) included in the storage apparatus 100a to a data volume 131b (copy destination volume) included in the storage apparatus 100b.

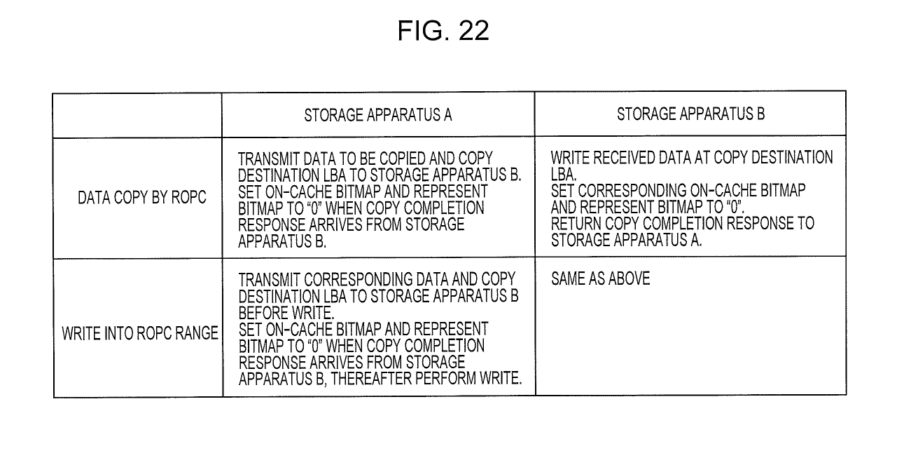

FIG. 22 illustrates processing of data copy by ROPC and processing of write into an ROPC range in the storage apparatuses 100a and 100b.

In the storage apparatus 100a, as in the case of the copy within the same apparatus described above, a unit copy bitmap 3011 is read into the memory 121 according to a represent bitmap 302 to copy data that has to be copied.

However, in the case of ROPC, since the copy destination volume 131b is in another storage apparatus 100b, the data has to be transferred to the storage apparatus 100b through the adapter 125 connected to the network 50, instead of copying the data. At the same time, in-volume position information, such as a logical block address (LBA), of the copy destination volume 131b is also transmitted. Upon receiving a copy completion response from the storage apparatus 100b, the storage apparatus 100a sets the on-cache bitmap 303 and the represent bitmap 302 to “0”.

When a host write occurs in the copy range of the ROPC, the storage apparatus 100a transmits corresponding data and a copy destination LBA to the storage apparatus 100b before performing the write. Upon receiving a copy completion response from the storage apparatus 100b, the storage apparatus 100a sets the on-cache bitmap 303 and the represent bitmap 302 to “0” and thereafter performs the write.

Upon receiving data and LBA of the copy destination volume 131b, the storage apparatus 100b performs the same processing as that when a write request arrives for a portion indicated by the LBA. Eventually, all the data within the copy range is transmitted from the storage apparatus 100a to the storage apparatus 100b. Thus, from the viewpoint of the storage apparatus 100b, the same processing is performed as that when the write requests arrive for the entire copy range. Thus, as a result, the whole copy bitmap 301 is rewritten from “1” to “0”.

However, as a situation to be noted, when a route (for example, the network 50) between the storage apparatuses 100a and 100b is disconnected, the ROPC operation is suspended until the route is recovered.

When OPC sessions are operated other than the ROPC session, holding a lot of information about the suspended ROPC session on the memory is not desirable when considering the purpose of reducing the number of disk accesses by increasing vacancies in the memory as much as possible.

Therefore, the order of the management link 304 is desirably arranged such that the on-cache bitmaps 303 for OPC within the respective storage apparatuses 100a and 100b is preferentially processed while the ROPC session is suspended.

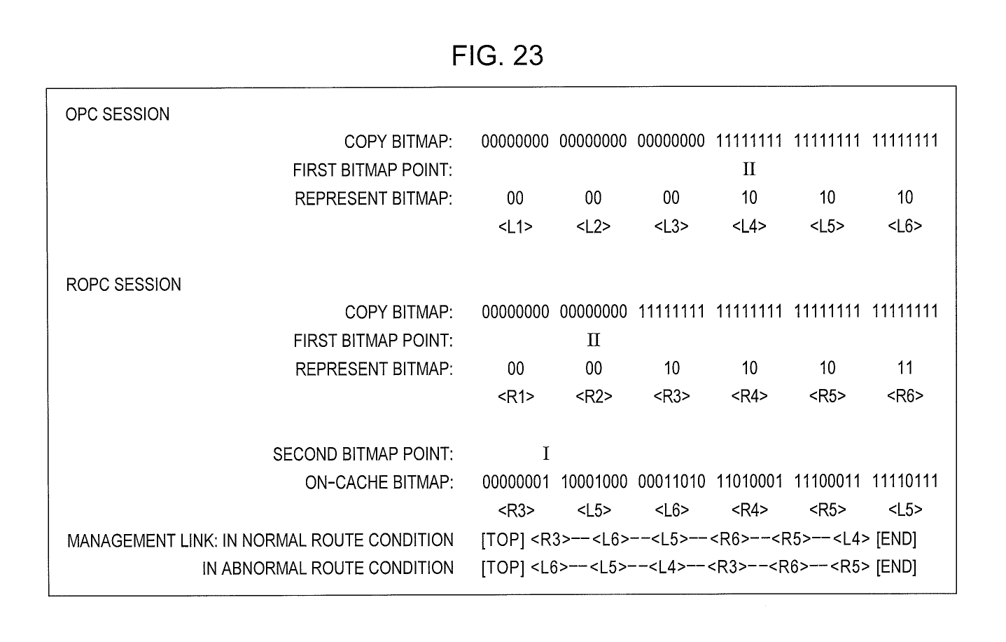

FIG. 23 is a diagram illustrating processing in a case of a network failure during ROPC processing in the modified storage system 1.

In the example illustrated in FIG. 23, description is given of a state where an OPC session and an ROPC session are processed in parallel.

In FIG. 23, represent IDs for the OPC session are indicated by “L1” to “L6”, while represent IDs for the ROPC session are indicated by “R1” to “R6”.

When a route between the storage apparatuses 100a and 100b is in a normal state (in normal route condition), processes by OPC and processes by ROPC are registered in chronological order of the processes, for example, in the management link 304.

On the other hand, when a problem such as route disconnection occurs in the route between the storage apparatuses 100a and 100b (in abnormal route condition), the management link control unit 13 rearranges the queue in the management link 304 to preferentially process the OPC session.

If many on-cache bitmaps 303 of the OPC session are connected to the management link 304, the on-cache bitmaps 303 of the ROPC session under suspension are preferentially written back into the copy bitmap region 132 of the storage device 130.

In the above-described embodiment, the description is given of the example where the represent size is 8 bits. However, the embodiment is not limited thereto, but any represent size may be set, such as 2048 bits, for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control apparatus, comprising:
a processor configured to
store partial progress information in a memory, the partial progress information being a part of progress information units of a predetermined size, the progress information units being obtained by dividing whole progress information stored in a storage device different from the memory, the whole progress information indicating progress of copy processing of copying data stored in a copy source region to a copy destination region, and
perform the copy processing on basis of the partial progress information stored in the memory.

2. The storage control apparatus according to claim 1, wherein
the processor is configured to
store first state information in the memory, the first state information indicating a state of a first progress information unit, and
copy first data stored in a first region in the copy source region to the copy destination region on basis of the first state information stored in the memory, the first region corresponding to the first progress information unit.

3. The storage control apparatus according to claim 2, wherein
the processor is configured to
copy, when the first state information indicates that the first progress information unit is in a mixed state and that the first progress information unit is already stored in the memory, the first data to the copy destination region on basis of the first progress information unit stored in the memory, the mixed state being a state in which the first progress information unit indicates that not-yet-copied regions and already-copied regions are mixed in the first region, data stored in the not-yet-copied regions being not yet copied, data stored in the already-copied regions being already copied.

4. The storage control apparatus according to claim 2, wherein
the processor is configured to
copy the first data to the copy destination region when the first state information indicates that the first progress information unit is in an initial state, the initial state being a state in which the first progress information unit indicates that an entirety of the first data is not yet copied.

5. The storage control apparatus according to claim 2, wherein
the processor is configured to
read the first progress information unit from the storage device when the first state information indicates that the first progress information unit is in a mixed state and that the first progress information unit is not yet stored in the memory, and
store the first progress information unit in the memory, the mixed state being a state in which the first progress information unit indicates that not-yet-copied regions and already-copied regions are mixed in the first region, data stored in the not-yet-copied regions being not yet copied, data stored in the already-copied regions being already copied.

6. The storage control apparatus according to claim 2, wherein
the processor is configured to
determine, when the first state information indicates that the first progress information unit is in a completion state, not to copy the first data to the copy destination region, the completion state being a state in which the first progress information unit indicates that an entirety of the first data is already copied.

7. The storage control apparatus according to claim 1, wherein
the processor is configured to
manage a processing order of the copy processing on basis of the partial progress information stored t in the memory, and
perform the copy processing in accordance with the processing order.

8. The storage control apparatus according to claim 7, wherein
the partial progress information includes a first progress information unit and a second progress information unit,
the first progress information unit indicates a first amount of not-yet-copied regions in a first region in the copy source region,
data stored in the not-yet-copied regions is not yet copied,
the second progress information unit indicates a second amount of the not-yet-copied regions in a second region in the copy source region, and
the processor is configured to
manage the processing order to preferentially copy first data stored in the first region over second data stored in the second region when the first amount is less than the second amount.

9. A computer-readable recording medium having stored therein a program that causes a computer to execute a process, the process comprising:
storing partial progress information in a memory, the partial progress information being a part of progress information units of a predetermined size, the progress information units being obtained by dividing whole progress information stored in a storage device different from the memory, the whole progress information indicating progress of copy processing of copying data stored in a copy source region to a copy destination region; and
performing the copy processing on basis of the partial progress information stored in the memory.

10. The computer-readable recording medium according to claim 9, the process further comprising:
storing first state information in the memory, the first state information indicating a state of a first progress information unit; and
copying first data stored in a first region in the copy source region to the copy destination region on basis of the first state information stored in the memory, the first region corresponding to the first progress information unit.

11. The computer-readable recording medium according to claim 9, the process further comprising:
manage a processing order of the copy processing on basis of the partial progress information stored t in the memory; and
perform the copy processing in accordance with the processing order.

12. The computer-readable recording medium according to claim 11, wherein
the partial progress information includes a first progress information unit and a second progress information unit,
the first progress information unit indicates a first amount of not-yet-copied regions in a first region in the copy source region,
data stored in the not-yet-copied regions is not yet copied,
the second progress information unit indicates a second amount of the not-yet-copied regions in a second region in the copy source region, and
the process further comprises:
managing the processing order to preferentially copy first data stored in the first region over second data stored in the second region when the first amount is less than the second amount.

13. A storage system, comprising:
a copy source region to store therein data;
a copy destination region;
a storage device configured to store therein whole progress information indicating progress of copy processing of copying the data stored in the copy source region to the copy destination region;
a memory different from the storage device; and
a processor configured to
store partial progress information in the memory, the partial progress information being a part of progress information units of a predetermined size, the progress information units being obtained by dividing the whole progress information stored in the storage device, and
perform the copy processing on basis of the partial progress information stored in the memory.

14. The storage system according to claim 13, wherein
the processor is configured to
store first state information in the memory, the first state information indicating a state of a first progress information unit, and
copy first data stored in a first region in the copy source region to the copy destination region on basis of the first state information stored in the memory, the first region corresponding to the first progress information unit.

15. The storage system according to claim 13, wherein
the processor is configured to
manage a processing order of the copy processing on basis of the partial progress information stored t in the memory, and
perform the copy processing in accordance with the processing order.

16. The storage system according to claim 15, wherein
the partial progress information includes a first progress information unit and a second progress information unit,
the first progress information unit indicates a first amount of not-yet-copied regions in a first region in the copy source region,
data stored in the not-yet-copied regions is not yet copied,
the second progress information unit indicates a second amount of the not-yet-copied regions in a second region in the copy source region, and
the processor is configured to
manage the processing order to preferentially copy first data stored in the first region over second data stored in the second region when the first amount is less than the second amount.
